(19) United States
(12) Patent Application Publication
(10) Pub. No.: US 2006/0089846 A1
(43) Pub. Date: Apr. 27, 2006

(54) Linked hierarchical airline maintenance process modeling

(75) Inventor: Justin Middlebrook, Louisville, KY (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 10/974,868

(22) Filed: Oct. 26, 2004

(51) Int. Cl. G06Q 99/00; G05B 19/418

(52) U.S. Cl. 705/1; 705/9; 705/8

(57) ABSTRACT

A plurality of display files representing aircraft maintenance processes are generated and linked in a hierarchy. A general level display file defines a number of divisions of aircraft maintenance processes that can include managerial as well as labor related divisions. Linked display files appearing below the general level file in the hierarchy refine the general level divisions until a basic level diagram is reached where the tasks required to perform the aircraft maintenance processes are defined and the input elements for the respective tasks are shown along with output elements. The display files are linked so that selecting items on a diagram causes corresponding lower level diagrams to be displayed. The linked display files representing the aircraft maintenance processes provide graphical information regarding dependencies and relationships between processes that can be used in selectively implementing aircraft maintenance applications across segments of an aircraft maintenance operation.

### BACKGROUND OF THE INVENTION

1. Field of the Invention

This invention is directed to system and methods for representing fleet maintenance processes that can facilitate partial or complete enterprise migration to an integrated fleet maintenance application.

2. Description of Related Art

Maintenance of vehicle fleets used to provide transportation and shipping services presents a significant financial and logistical burden for companies providing those services. The maintenance of ground-based fleets of taxis, rental cars, package delivery cars, and tractor-trailers, among others, can present a complex business problem for companies. The number of vehicles in such fleets commonly reaches into the hundreds, if not thousands. In order to provide a high level of service, the vehicles must be maintained in a condition that ensures the availability of a sufficient number of vehicles to meet the transportation and/or shipping needs of the company's customers from one day to the next. In order to ensure proper working order, the condition of a multitude of items on each vehicle must be monitored. When the maintenance window for a given part or set of parts is reached, the maintenance must be performed in time to get the vehicle back into service in time to meet customer needs, or a replacement vehicle must be allocated to cover the duties of that vehicle in the interim. Adding to the complications is that the fleet vehicles may not be, and most likely are not, all alike. The vehicles may be different model years of the same vehicle, they may be different makes of the same category of vehicle, or may be different types of vehicles altogether.

Because timely and proper vehicle maintenance is crucial to companies in transportation and shipping businesses, many companies with large fleets often perform their own maintenance. This requires that the companies retain a staff of supervisors and mechanics to keep track of maintenance schedules and perform the work on the vehicles. These employees must keep track of the condition of thousands of vehicles and their composite parts, schedule maintenance so that it does not negatively impact customer service, and ensure that there will be sufficient mechanics on site at a given time to perform the maintenance tasks for the vehicles removed from service for maintenance. In addition, a large inventory of parts may be required in order to avoid delays in required maintenance due to lead times.

When considering maintenance of aircraft fleets, the same issues discussed above are applicable except that maintenance costs and consequences of improper maintenance in aviation are greatly enhanced. An improperly maintained ground-based vehicle can merely pull over to the side of the road if the driver experiences a problem. There are, of course, costs associated with such an occurrence. The passengers or cargo of the vehicle must be transferred to another vehicle, and the disabled vehicle must be towed to a maintenance facility. A pilot of an aircraft, however, does not have this option. If the pilot considers the problem to be serious enough, the aircraft may be diverted from its flight plan to the nearest airport. Even if the aircraft is able to complete its current flight, the destination airport may not have the facilities or parts to affect a proper repair of the airplane. A replacement aircraft may be thousands of miles away, and reloading the passengers or cargo onto the replacement plane can be costly in terms of money, effort, and time.

Moreover, the importance of maintaining aircraft in an excellent condition goes well beyond mere economic considerations. The loss of life both in the aircraft and on the ground due to aircraft maintenance failures can be catastrophic. Because of the potential impact of aircraft maintenance on the safety of Americans, and the well being of the national economy, the Federal Aviation Administration (FAA) in the United States, and many of its international counterparts have an elaborate framework of maintenance regulations that must be followed to keep an aircraft certified for flight. The regulations include detailed maintenance procedures for nearly every flight system in an aircraft. The regulations even specify maintenance procedures particular to a certain airframe, in some cases, or even to a particular configuration of a given airframe.

For a company with a fleet of hundreds of aircraft, complying with the government mandated regulations alone can be a tremendous task, not to mention any additional internally adopted maintenance procedures. For each aircraft in a U.S. fleet, for example, the company must track approximately 8,000 to 12,000 elements. The time since installation, and last time serviced, for example, must be tracked for each of these elements. At any given time the company could be required by the FAA to produce the data for any one of the fleet aircraft to show that it complies with the regulations.

With the amount of elements that have to be tracked, the data required to be recorded for each element, and the fact that this data must be recorded for each of the aircraft in a fleet of perhaps hundreds of planes, the recording of the maintenance process is well suited to being handled by a computer system, or more generally, a processor-based system. At this time, however, some companies still employ paper-based recording and tracking systems for at least part of their fleet maintenance programs. Legacy systems such as a mainframe application, for example, are also employed for portions of existing maintenance tracking and scheduling systems. These mainframe applications, however, may be written for only one type of aircraft or for only one part of an aircraft, such as an application to facilitate maintenance on a certain model of jet engine, for example. Using paper-based recording techniques, these legacy mainframe systems, or loosely integrated combinations of the same can lead to waste. The paper records can lead to oversights and the disparate legacy systems require specialized training in order to use them effectively. Data from the paper records must be keyed into a terminal in order to be utilized by one of the legacy systems, and data from one legacy system must be processed into the correct protocol and format in order to be transferred to a different legacy system.

Recently, integrated solutions for robust aircraft maintenance scheduling, tracking, and recording have been developed. These solutions are enterprise resource planning packages developed specifically for the aviation industry. These applications can track the flight time for each of the 8,000 to 12,000 parts required for each aircraft along with the maintenance history of each element. These integrated systems can typically track aircraft configurations, employee/mechanic work schedules, shop schedules, parts warehouse inventory, tool availability. Such applications can also provide maintenance and repair scheduling and history, inventory/material management and ordering, demand forecasting, governmental/regulatory compliance, and billing functions.

The benefits of implementing such a solution to companies having aircraft fleets can be staggering. For example, a company with a large fleet of diverse aircraft may keep 500 million to 1.2 billion dollars of parts and materials inventory on hand to ensure their availability. The cost of warehousing these parts can be significant. While emergency spares will still need to be kept on hand, an integrated aircraft maintenance application can accurately track the flight time of thousands of aircraft elements on each of the aircraft in the fleet and forecast the needs for parts in time to order them for the needed maintenance. The application can also interface with ordering systems to procure the proper parts needed for the forecasted maintenance. In addition, mechanic time can be optimized by scheduling maintenance earlier than regulations require if there is a projected window of significant mechanic downtime.

As can be appreciated there are many more benefits of such a system. Most of these benefits are associated with the increase in efficiency that an integrated aircraft maintenance application can provide. As such, many companies with aircraft maintenance operations would prefer to have such an integrated maintenance solution.

These companies, however, share a common obstacle to implementing an integrated aircraft maintenance application. A wholesale conversion of an entire enterprise to an integrated aircraft maintenance application would be extremely difficult if not impossible because the company must continue to provide their transportation and shipping services during any conversion process. The significant downtime required to convert and then troubleshoot an entire enterprise would be unacceptably long. Therefore the conversion is probably best made in a piecemeal fashion, one area of maintenance operation at a time. As the fleet continues to fly, the records must continue to be updated. During a conversion, the old processes must continue to be used and interfaced with the new integrated maintenance application. It is necessary then, to have a detailed map of the existing maintenance and management processes within the maintenance operation.

Integrated aircraft maintenance applications include the capabilities necessary to manage an aircraft fleet maintenance operation, but the specific processes used must be designed and implemented into the program. When a new installation of such a program is made, every step of each maintenance activity is detailed and then programmed into the application. The same holds true for partial installations where only part of the maintenance operation is converted to the integrated aircraft maintenance application. Because data from one maintenance process may be needed to perform another, information transferred from step-to-step and process-to-process should be detailed so that processes managed by the new integrated maintenance application can be properly integrated with existing processes that have not been converted. It would therefore be advantageous to have detailed maps of each step performed in an airline maintenance enterprise so that each step can be properly implemented in an integrated maintenance application. Such maps would facilitate the conversion to an integrated maintenance application in whole or in part. Such maps could also be used to properly implement an integrated maintenance application for a new aircraft maintenance operation.

### BRIEF SUMMARY OF THE INVENTION

One embodiment of the invention described herein is a method of generating hierarchically arranged, linked display files. The generated hierarchy of files includes a general level diagram that defines a number of divisions of aircraft maintenance processes. Other display files in the hierarchy have basic level diagrams for each of the respective divisions where the basic level diagrams define tasks required to perform respective aircraft maintenance processes.

The general level diagram of the hierarchy can display divisions of aircraft maintenance processes for supply chain management, engineer-to-order, configuration management, operations, finance and accounting, planning systems, customer relationship management, and business to employee. Tasks defined in the basic level diagram can include replacing an aircraft part, inspecting an aircraft part, and/or servicing an aircraft part. Input elements can be required in some of the base level tasks depicted in the linked display files. The input elements can be a tool, a skilled worker, a part, and record, and/or data. Some tasks can require output elements such as a report.

Another embodiment of the invention comprises a method of generating a hierarchy of displays of aircraft maintenance processes where the hierarchy of displays has a succession of levels. The succession of levels progresses from a general level that has at least one maintenance process to a base level that defines a task to perform the process.

In yet another embodiment, the invention comprises a method of analyzing the tasks performed by a plurality of different business units to generate a single cross-business-unit thread for specific aircraft maintenance processes. The method includes generating an aircraft process diagram that models the aircraft maintenance process where the process diagram has a number of tasks that are performed by different business units.

An additional embodiment of the invention comprises a method of identifying the tasks performed by a business unit of an aircraft maintenance organization. The identified tasks are grouped into an aircraft maintenance process made up of interdependent tasks. Input and output elements of the grouped tasks are identified, and an aircraft maintenance process diagram based on the grouped tasks and associated input and output elements is generated. The generated aircraft maintenance diagram can be displayed on a computer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a display file of general level diagram of an aircraft maintenance process model.

FIG. 2 shows a display file for an aircraft maintenance process for “Supply Chain Management”.

FIG. 3 shows a display file for an aircraft maintenance process for “Engineer-to-Order”.

FIG. 4 shows a display file for an aircraft maintenance process for “Configuration Management”.

FIG. 5 shows a display file for an aircraft maintenance process for “Operations”.

FIG. 6 shows a display file for an aircraft maintenance process for “Finance and Accounting”.

FIG. 7 shows a display file for an aircraft maintenance process for “Planning Systems”.

FIG. 8 shows a display file for an aircraft maintenance process for “Customer Relationship Management”.

FIG. 9 shows a display file for an aircraft maintenance process for “Business-to-Employee”.

FIG. 10 shows a display file for an aircraft maintenance process for “Maintenance Program” that can appear below the display of file of FIG. 5 in a hierarchy of linked display files.

FIG. 11 shows a display file for an aircraft maintenance process for “Maintenance Program” that can appear below the display of file of FIG. 10 in a hierarchy of linked display files.

FIG. 12 shows a display file for an aircraft maintenance process for “Maintenance Programs” that can appear below the display of file of FIG. 11 in a hierarchy of linked display files.

FIG. 13 shows a display file of a basic level diagram for an aircraft maintenance process for “Review Item for Impact” that can appear below the display of file of FIG. 12 in a hierarchy of linked display files.

FIG. 14 shows a display file of a basic level diagram for an aircraft maintenance process for “Create Document Changes” that can appear below the display of file of FIG. 12 in a hierarchy of linked display files.

FIG. 15 shows a display file of a basic level diagram for an aircraft maintenance process for “Route TCPR” that can appear below the display of file of FIG. 12 in a hierarchy of linked display files.

FIG. 16 shows a display file of a basic level diagram for an aircraft maintenance process for “Program Change Review by MRB” that can appear below the display of file of FIG. 12 in a hierarchy of linked display files.

FIG. 17 shows a display file of a basic level diagram for an aircraft maintenance process for “Gain FAA Approval” that can appear below the display of file of FIG. 12 in a hierarchy of linked display files.

FIG. 18 shows a display file of a basic level diagram for an aircraft maintenance process for “Publish Document Changes” that can appear below the display of file of FIG. 12 in a hierarchy of linked display files.

FIG. 19 shows a display file of general level diagram of an aircraft maintenance process model for a wheel and brake shop activity model.

FIG. 20 shows a display file of an aircraft maintenance process model for “Shop Floor Control” that can appear below the display of file of FIG. 19 in a hierarchy of linked display files.

FIGS. 21a and 21b show a display file of a basic level diagram for an aircraft maintenance process for “Major Wheel Repair” that can appear below the display of file of FIG. 20 in a hierarchy of linked display files.

FIGS. 22a and 22b show a display file of a basic level diagram for an aircraft maintenance process for “Brake Major Repair” that can appear below the display of file of FIG. 20 in a hierarchy of linked display files.

FIGS. 23a and 23b show examples of computer devices that can be used to implement aspects of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

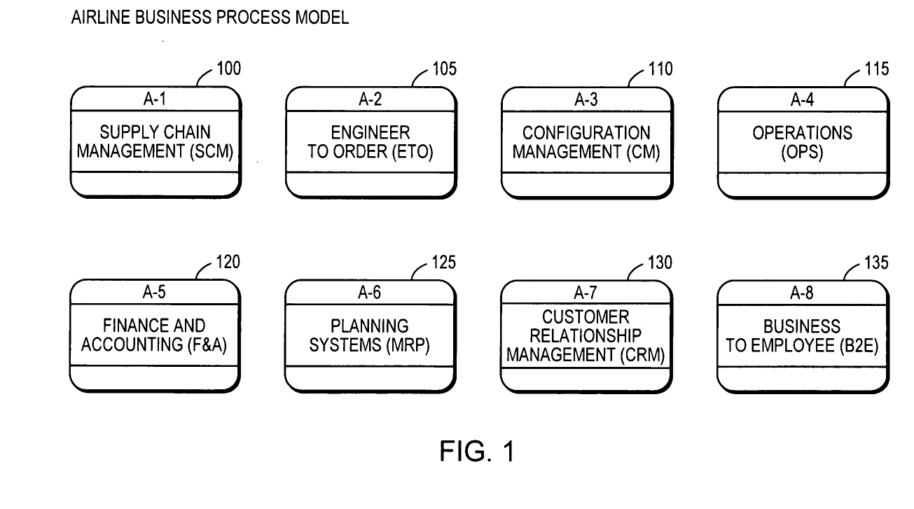

FIG. 1 shows a general level diagram of a linked airline maintenance process model. The diagram includes eight divisions represented by items or objects on the diagram: “Supply Chain Management (SCM)” 100, “Engineer To Order (ETO)” 105, “Configuration Management (CM)” 110, “Operations (OPS)” 115, “Finance and Accounting (F&A)” 120, “Planning Systems MRP)” 125, “Customer Relationship Management (CRM)” 130, and “Business To Employee (B2E)” 135. It should be appreciated that these divisions do not represent the only way that a linked airline maintenance process model can be arranged. The diagram is an example of the top level of a linked airline maintenance process model generated according to the invention. A diagram such as the one shown, when stored on a computer for graphical display becomes a “display file.” When a number of such display files are linked such that the selection of an item causes another display file to be shown they become “linked display files.” A file in this context can refer to the computer instructions required to cause respective diagrams to appear on a graphical display such as a computer monitor. The display files can be stored in a computer-readable memory which generally any medium capable of storing data in a form that can be read by a computer processor. Examples of such computer-readable memory include but are not limted to RAM, ROM, EPROM, EEPROM, FLASH, magnetic storage (such a magnetic tape, hard disks and floppy disks), and optical storage (such as CD ROMs, and DVD ROMs).

A plurality of diagrams such as that depicted in FIG. 1, together, can comprise a hierarchy that defines an aircraft maintenance model. Preferably, these diagrams are stored in computer readable medium and are linked to each other. The linking is preferably arranged so that when an item of one diagram is selected, a corresponding diagram that is lower in the hierarchy is then displayed. The selection of an item can be accomplished using a pointing device such as a mouse or trackball to position a cursor over the item and then selecting the item with the press of a button, for example. Other selection mechanisms are possible, as well, including the use of a keyboard to highlight the desired item and then pressing an enter or return key, using a touch activated screen, or other known selection mechanisms.

As will be shown, the lower levels of the linked aircraft maintenance process model hierarchy include details regarding information transfers, documenting procedures, review procedures, as well as physical tasks. These process models can be generated by examining an enterprise's current procedures and mapping each step in the process models. Alternatively, new processes can be mapped in this manner by determining the steps required to complete an airline maintenance task (whether a management, or labor, oriented task) including record keeping steps and those required for regulatory compliance. The result is a comprehensive model that graphically displays the regulatory compliant airline maintenance processes. The model shows information transfers (whether via computer or using paper), the creation of data records and/or papers, updates of data records and/or papers, necessary reporting steps, review steps, manual labor steps, and hardware transfer/replacement steps, among other processes required to maintain a fleet of aircraft.

When a set of linked display files is created to represent an aircraft maintenance process, the various levels of the process can be navigated so that details for each step can be viewed. Navigating the linked display files includes moving through the hierarchy of the files using input devices such as a keyboard or mouse. Navigating the files causes a display files linked to a current display file to be displayed. Movement can occur both up and down the hierarchy of linked display files. The linked display files according to the invention can be very helpful in transitioning an aircraft maintenance organization from an old process to a new process for a given task—brake maintenance, for example. By following the information transfers depicted in the display files, the effect of process changes in one area of the organization on other processes within the enterprise can be seen. The linked display files can also be used in implementing enterprise resource planning packages. The process flows can be used to configure the enterprise resource planning package with the correct steps for completion of the maintenance task.

As mentioned previously, it is usually not practical to implement an aircraft maintenance application across an entire aircraft maintenance organization at one time. It is preferable to perform such an implementation in steps so that downtime is minimized and the processes can be properly debugged and streamlined in a compartmentalized fashion. In this regard, the linked graphical process diagrams of the display files can be quite helpful. By viewing the display files, a group of required steps can be selected for implementation in the enterprise resource planning package. Any interfaces between those steps selected and those not selected will then be noticeable. These are the points where the enterprise resource planning package interfaces with the existing processes within the maintenance operation, whether those interfaces be paper-based, computer-based, or human/manual. By properly coordinating these interface points, segments of the airline maintenance operation can be converted to use an enterprise resource planning package. The operation can then be converted in a piecemeal fashion allowing for testing of converted segments while other areas of the operation continue to operate using existing procedures.

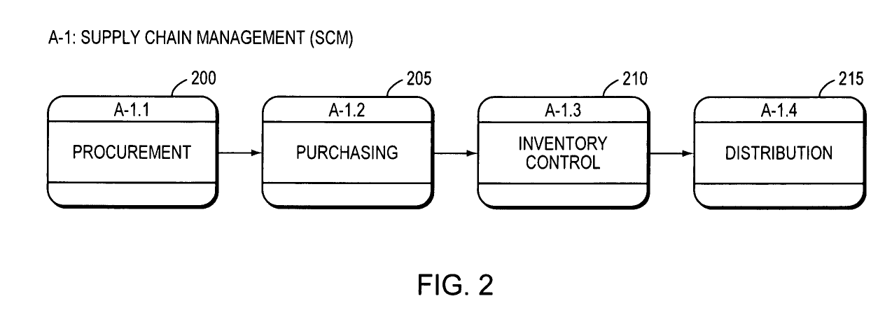

FIG. 2 depicts an example of divisions of “Supply Chain Management (SCM)” 100 from FIG. 1 that can comprise the next level of the hierarchy below the general level diagram shown in FIG. 1. This diagram is preferably linked to the “Supply Chain Management (SCM)” item 100 of FIG. 1 such that it is shown upon “Supply Chain Management (SCM)” 100 of FIG. 1 being selected. The divisions of “Supply Chain Management (SCM)” 100 shown in FIG. 2 comprise: “Procurement” 200, “Purchasing” 205, “Inventory Control” 210, and “Distribution” 215. These divisions are an example of the second level in a hierarchy of an aircraft maintenance model. In this example, diagrams below the “Procurement” 200 object deal with locating and obtaining parts, materials, tools, etc. Diagrams located below “Purchasing” 205 deal with the process of handling the purchase of those items from the procurement portion of the hierarchy. “Inventory Control” 210 leads to diagrams which map methods of storing the items in an organized manner and ensuring that an adequate supply is maintained. Diagrams below “Distribution” 215 in the model deal with sending parts, materials, and tools to the needed location to be used to perform maintenance on aircraft.

Arrows appear between objects in the upper level display files to indicate that information or material from processes located in the display file hierarchy beneath those objects is transferred or shared between the processes. Examples of lower level display files are shown below that depict such information and material transfers at a basic level.

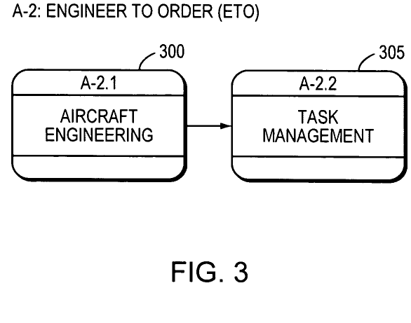

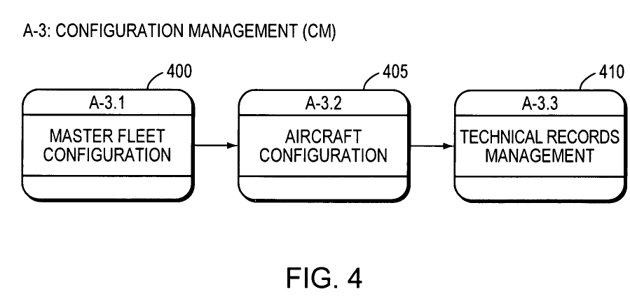

An example of linked display file, according to the invention, having divisions of “Engineer-to-Order (ETO)” 105 of FIG. 1, is depicted in FIG. 3. The divisions shown are “Aircraft Engineering” 300, and “Task Management” 305. FIG. 4 shows an example of a linked display file, according to the invention, which includes divisions of “Configuration Management (CM)” 110 of FIG. 1. The linked display files below the divisions “Master Fleet Configuration” 400 and “Aircraft Configuration” 405 concern the configuration states of the aircraft fleet including the types of aircraft that comprise the fleet, and the different configurations of these types of aircraft that exist in the fleet. “Technical Records Management” 410 leads to linked display files concerning the management of technical specifications, reports, and regulations dealing with the aircraft configurations found in the fleet.

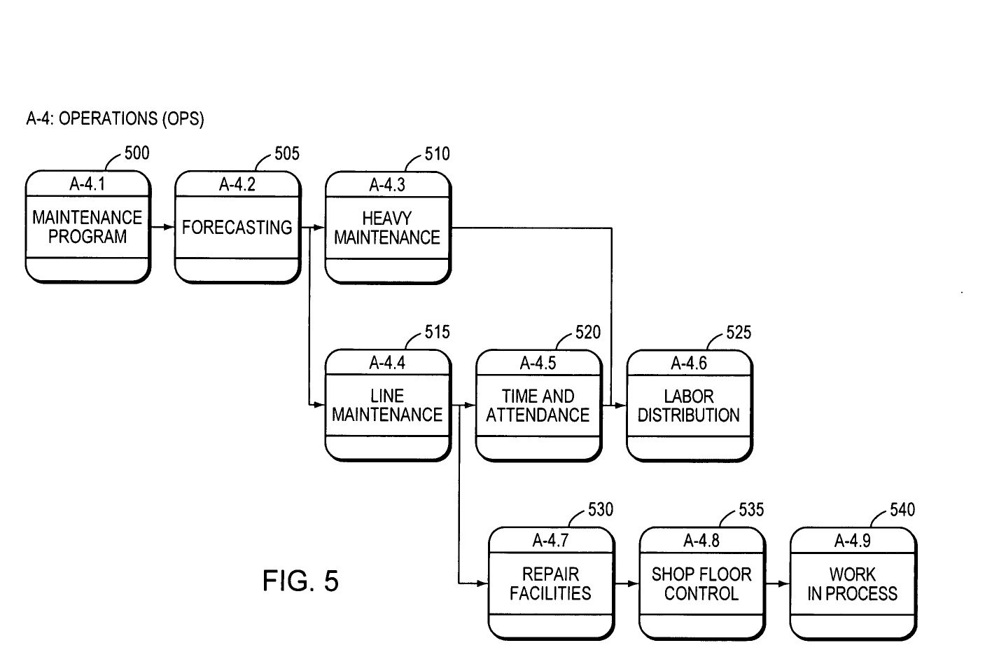

An example of a linked display file located directly beneath “Operations (OPS)” 115 of FIG. 1 is shown in FIG. 5. Here the subdivisions include: “Maintenance Program” 500, “Forecasting” 505, “Heavy Maintenance” 510, “Line Maintenance” 515, “Time and Attendance” 520, “Labor Distribution” 525, “Repair Facilities” 530, “Shop Floor Control” 535, and “Work in Process” 540. In this display file double arrows are depicted from “Forecasting” 505. One arrow terminates at “Heavy Maintenance” 510, the other at “Line Maintenance” 515. This indicates that data from a process or processes depicted in a display file or display files located in the hierarchy below “Forecasting” 505 is sent to processes depicted in a display file or display files located in the hierarchy below “Heavy Maintenance” 510, and “Line Maintenance” 515. The same data is not necessarily forwarded to “Heavy Maintenance” 510, and “Line Maintenance” 515, and the data may come from different processes. Likewise, two arrows extend from “Line Maintenance” 515. One arrow terminates at “Time and Attendance” 520, and the other at “Repair Facilities” 530. Data from processes in both the hierarchy below “Heavy Maintenance” 510, and “Time and Attendance” 520 is used in processes in the hierarchy below “Labor Distribution” 525, as such, both have arrows leading there.

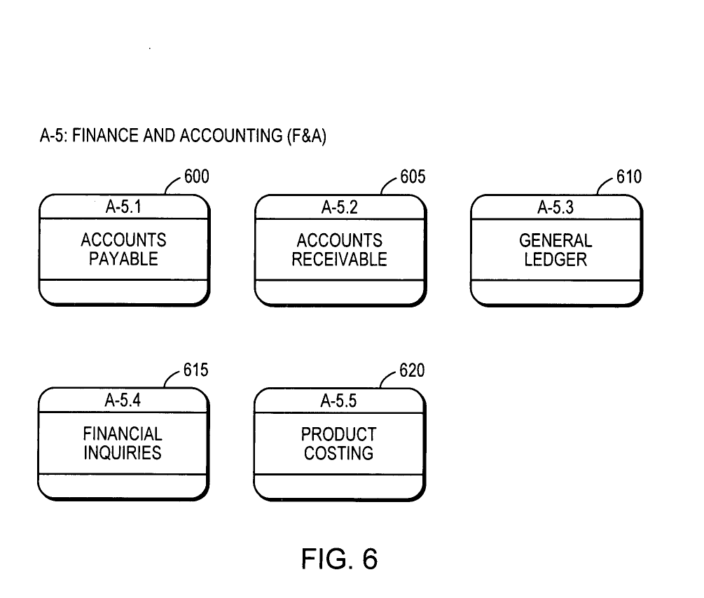

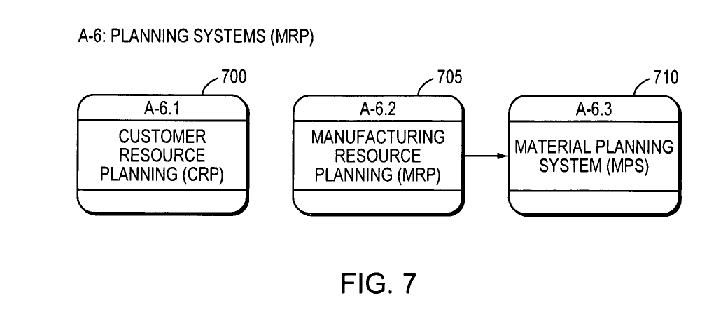

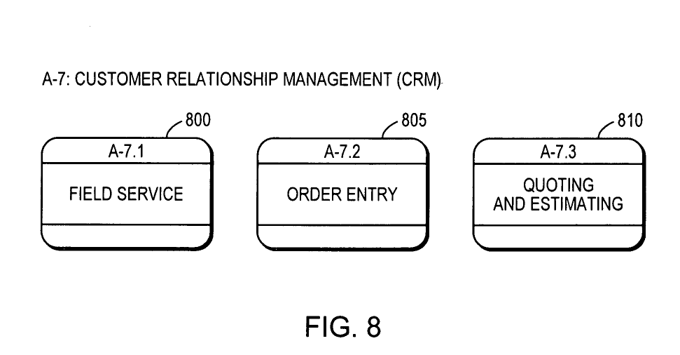

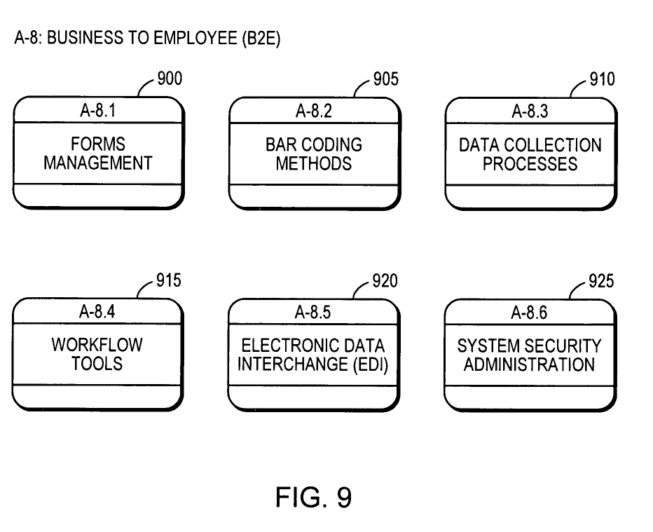

FIGS. 6, 7, 8 and 9 complete the example second level hierarchy of linked display files according to the invention. These figures depict examples of display files that can be linked to “Finance and Accounting (F&A)” 120, “Planning Systems (MRP)” 125, “Customer Relationship Management (CRM)” 130, and “Business to Employee (B2E)” 135, respectively. FIG. 6 includes example divisions: “Accounts Payable” 600, “Accounts Receivable” 605, “General Ledger” 610, “Financial Inquiries” 615, and “Product Costing” 620. FIG. 7 includes example divisions: “Customer Resource Planning (CRP)” 700, “Manufacturing Resource Planning (MRP)” 705, and “Material Planning System (MPS)” 710. FIG. 8 includes example divisions: “Field Service” 800, “Order Entry” 805, “Quoting and Estimating” 810. FIG. 9 includes example divisions: “Forms Management” 900, “Bar Coding Methods” 905, “Data Collection Processes” 910, “Workflow Tools” 915, “Electronic Data Interchange (EDI)” 920, and “System Security Administration” 925.

The figures described above comprise an example of a general level diagram and the second tier in the hierarchy located below the general level diagram. Now, examples of linked display files for aircraft maintenance processes according to the invention for processes located below the “Maintenance Program” 500 item of FIG. 5 will be described. These example diagrams will be described in detail down to the lowest levels of the linked display file hierarchy for this division of the example aircraft maintenance process. Two sets of examples are presented below. First, example display files that can appear beneath the “Maintenance Program” item 500 under “Operations (OPS)” 115 are described. The second set of examples of linked display files according to the present invention describes an airline maintenance model for repairing aircraft wheel and brake assemblies.

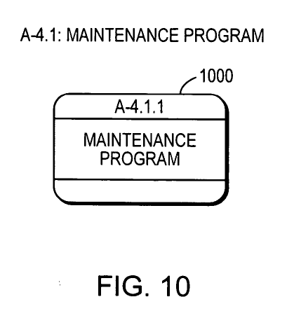

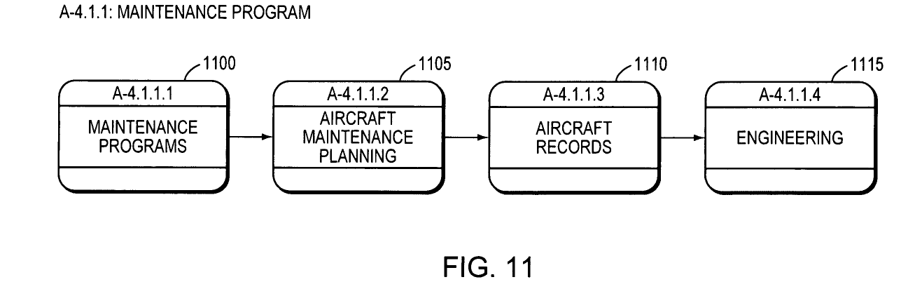

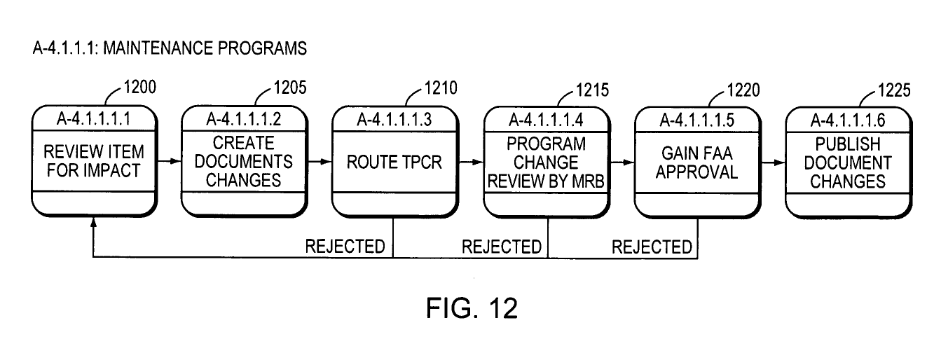

FIG. 10 depicts an example of a linked display file that can appear upon the selection of “Maintenance Program” 500 of FIG. 5. The linked display file depicted in FIG. 1 can appear upon the selection of “Maintenance Program” 1000 of FIG. 10. “Maintenance Programs” 1100 of FIG. 11, can in turn be linked to the display file depicted in FIG. 12. FIG. 12 depicts an example of a linked display file showing a process for implementing a new maintenance program. As can be seen in FIG. 12, to properly implement a change in an aircraft maintenance process in this example business model, a number of steps are necessary. First the proposed new maintenance process change is reviewed at “Review Item for Impact” 1200. This step comprises many sub steps that are found in the linking display files located beneath the current display file in the hierarchy that are described below. After “Review Item of Impact” 1200, the necessary changes to existing documentation are performed at “Create Document Changes” 1205. Again, this step comprises a number of activities that are depicted in linked display files that are described below. Following the creation of the document changes, a Technical Publications Change Request (TPCR) is created which is routed to various recipients at “Route TPCR” 1210 for review and approval. As is indicated in FIG. 12, a display file beneath “Route TPCR” 1210 in the hierarchy includes a step that can result in the TPCR being rejected and sent back to “Review Item for Impact” 1200. If it is not rejected earlier, the Maintenance Review Board (MRB) performs review of the TPCR at “Program Change Review by MRB” 1215. The TPCR can be rejected during this phase as well. If it is not rejected, the TPCR undergoes a Federal Aviation Administration review process at “Gain FAA Approval” 1220. The TPCR can be rejected during this phase. If it is not, then the documents related to the change in procedure are published at “Publish Document Changes” 1225.

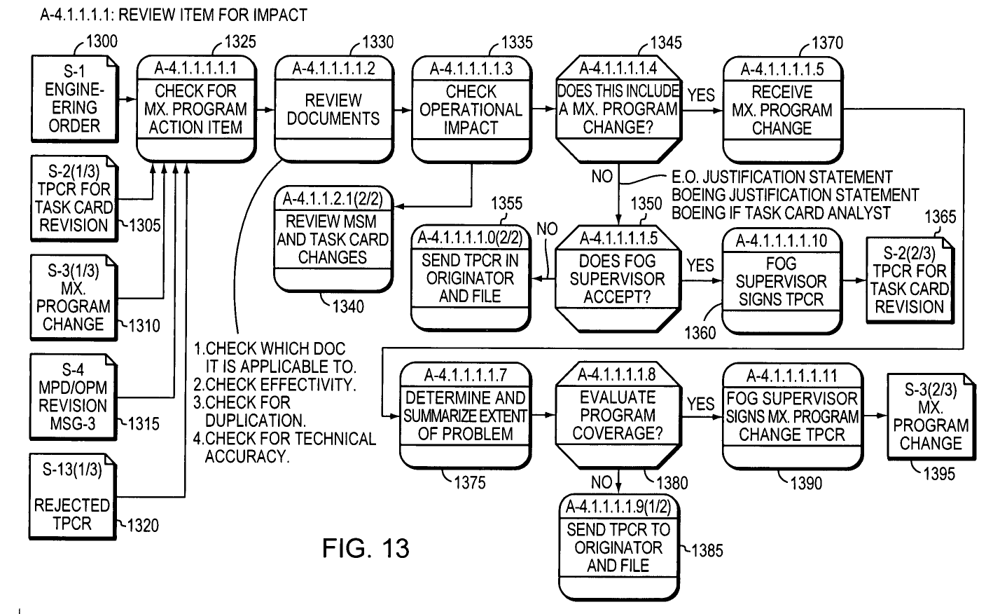

FIG. 13 represents an example of a linked display file that can appear upon the selection of “Review Item for Impact” 1200 of FIG. 12. That is, the display file of FIG. 13 appears in the aircraft maintenance model hierarchy below “Review Item for Impact” 1200 and can be displayed upon the selection of “Review Item for Impact” 1200. “Engineering Order” 1300, “TPCR for Task Card Revision” 1305, “Maintenance (Mx) Program Change” 1310, Maintenance Planning Document (MDP)/Operators Maintenance Program (OMP) Revision “MPD/OPM Revision” 1315, and “Rejected TPCR” 1320, are represented by paper icons with a folded corner. These items are “stores”. These are records that are used in the process model whether paper or electronic. An MPD is a Boeing aircraft specific maintenance document, while OMP is an Airbus aircraft specific document. It should be realized that not all of the stores shown are required to be input to the process, for example “Rejected TPCR” 1320 would exist if a related TPCR has been previously rejected. These stores are input to “Check for Mx. Program Action Item” at 1325. Then the process continues to “Review Documents” 1330 where the appropriate maintenance management personnel review the documents related to the proposed change in the aircraft management process. At “Check Operational Impact” 1335 the effect of the change on maintenance operations is reviewed.

At this point in the example model, the process continues to two steps that do not necessarily need to be completed in sequence nor does one depend on the outcome of the other. Two arrows extending from “Check Operational Impact” 1335 indicate this. One of the following steps is “Review Maintenance Specifications Manual (MSM) and Task Card Changes” 1340 in which the changes required for the MSM and Task Cards for the maintenance process affected are reviewed. The second arrow extending from Check Operational Impact 1335 points to a decision block “Does this include a Mx. Program Change” 1345. If no maintenance program change is included, that is, if only a change to a technical document is required that does not otherwise affect maintenance procedures, then the process continues to “Does Fleet Operations Group (FOG) Supervisor Accept?” 1350. If the FOG Supervisor does not accept the TPCR, the TPCR is sent back to the originator for filing at “Send TPCR to Originator and File” 1355. If the FOG supervisor accepts the TPCR, he or she signs it at “FOG Supervisor Signs TPCR” 1360. The resulting record is a signed TPCR which is represented by “TPCR for Task Card Revision” 1365.

If the result of decision block “Does this include a Mx. Program Change?” 1345 is “yes” then the example process continues to “Receive Mx. Program Change” 1370. After the maintenance program change has been received, the extent of the maintenance problem is reviewed at “Determine and Summarize Extent of Problem” 1375. The example process then continues to decision block “Evaluate Program Coverage” 1380. If the maintenance program change is not considered sufficient then the TPCR is sent back to the originator and filed at “Send TPCR to Originator and File” 1385. If the coverage of the maintenance program change is considered sufficient, the FOG supervisor will sign-off on it at “FOG Supervisor Signs Maintenance Program Change TPCR” 1390. The resulting record from this series of steps is a signed Maintenance Program Change “Mx. Program Change” 1395.

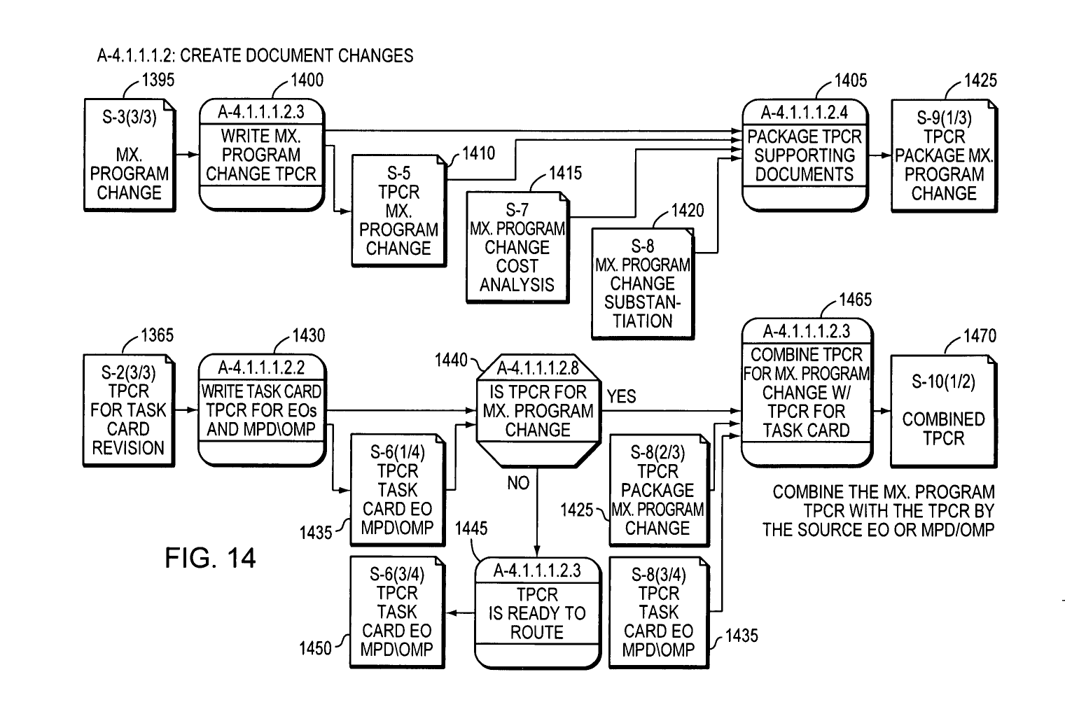

Selecting “Create Document Changes” 1205 of FIG. 12 can cause an aircraft maintenance document change process such as that shown in FIG. 14 to be displayed. In the example process shown in FIG. 14, Maintenance Program Change, “Mx. Program Change” 1395 record is transferred to “Write Mx. Program Change TPCR” 1400 where a technical publications change request is authored for the maintenance program change. This results in “TPCR Mx. Program Change” 1410 being created. This record is transferred to “Package TPCR Supporting Documents” 1405 along with “Mx. Program Change Cost Analysis” 1415, and “Mx. Program Change Substantiation” 1420. At “Package TPCR Supporting Documents” 1405, the documents are assembled into “TCPR Package Mx. Program Change” 1425. Also displayed on FIG. 14 is “TPCR for Task Card Revision” 1365 being provided to “Write Task Card TPCR for EO's and MPD/OMP” 1430. This step results in a “TCPR Task Card EO MPD/OMP” 1435 record being created which is sent on to decision block “Is TPCR for Mx. Program Change?” 1440. If the TPCR is not for a maintenance program change, then the TPCR is ready to be routed throughout the aircraft maintenance enterprise. This is indicated by “TPCR is Ready to Route” 1445 and the “TPCR Task Card EO MPD/OMP” 1450 record which is ready to be distributed. If the TPCR is for a maintenance program change then “TPCR Package Mx. Program Change” 1425 and the “TPCR Task Card EO MPD/OMP” 1435 are provided to the “Combine TPCR for Mx. Program Change w/TPCR for Task Card” 1465 step. The resulting record is a “Combined TPCR” 1470.

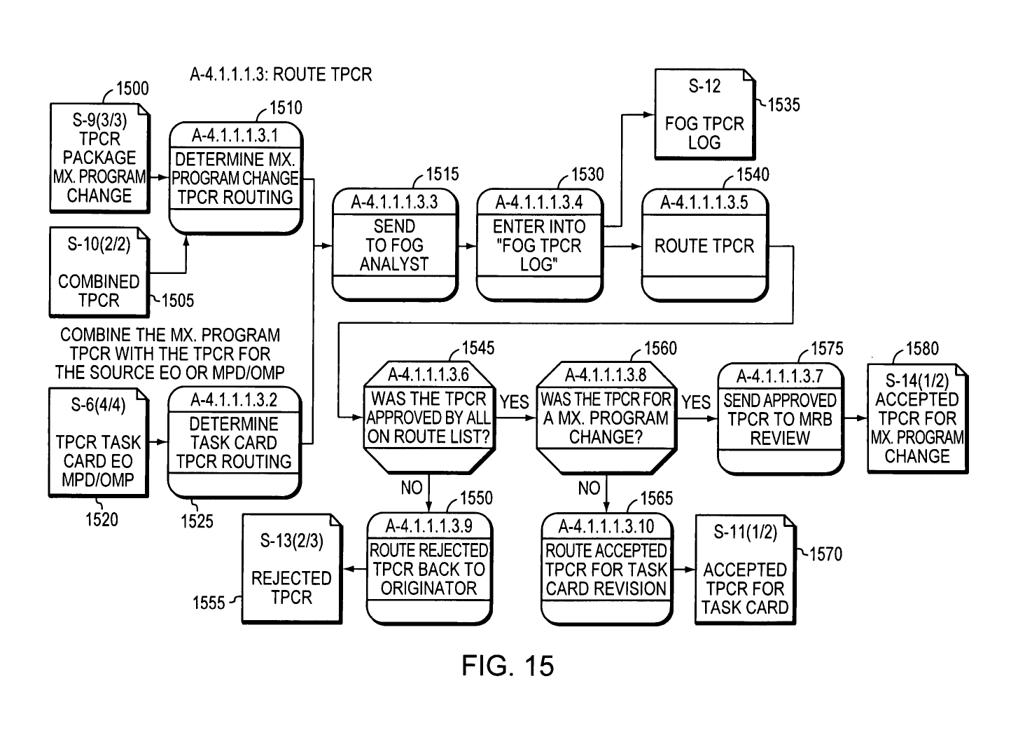

FIG. 15 provides an example of a linked display file that can be displayed upon selection of “Route TCPR” 1210 of FIG. 12. A “TPCR Package Mx. Program Change” 1500 record is provided to “Determine Mx. Program Change TPCR Routing” 1510 along with “Combined TPCR” 1505. “TPCR Task Card EO MPD/OMP” record 1520 is provided to “Determine Task Card TPCR Routing” 1525. The process continues from “Determine Mx. Program Change TPCR Routing” 1510 and “Determine Task Card TPCR Routing” 1525 to “Send to FOG Analyst” 1515. From this step, the process depicted in the display file continues to “Enter Into ‘FOG TPCR Log’” 1530. This step generates an entry record into the “FOG TPCR Log” 1535.

The TPCR routing process then proceeds to “Route TPCR” 1540 where the TPCR is sent to maintenance personnel on a routing list. At decision step “Was the TPCR Approved by all on the Route List?” 1545, if the TPCR was not approved by all of the recipients then the “Rejected TPCR” 1555 is sent back to its originator at “Route Rejected TPCR Back to Originator” 1550. If the outcome of decision step 1545 is positive then the process proceeds to decision step 1560 “Was the TPCR for a Mx. Program Change?” If the TPCR was for a maintenance program change, then the TPCR is sent to a maintenance review board at “Send Approved TPCR to MRB Review” 1575. The record sent to the review board is represented in the figure as “Accepted TPCR for Mx. Program Change” 1580. If the TPCR is not for a maintenance program change, then the “Accepted TPCR for Task Card” 1570 is routed for task card revision at “Route Accepted TPCR for Task Card Revision” 1565

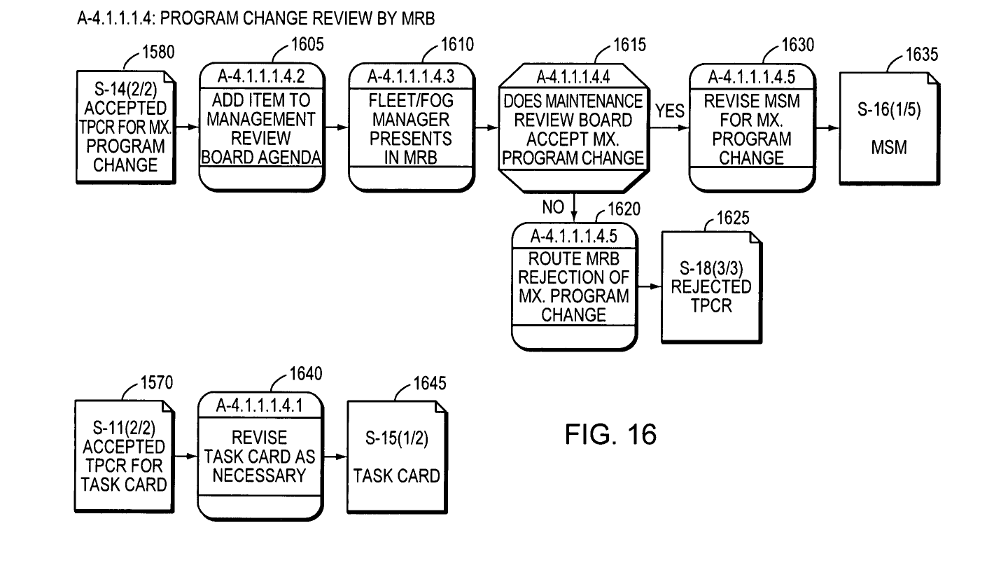

Selecting “Program Change Review by MRB” 1215 of FIG. 12 can link to a display file such as the one depicted in FIG. 16. An “Accepted TPCR for Mx. Program Change” record 1580 is provided to “Add Item to Management Review Board Agenda” 1605. Processing continues to “Fleet/FOG Manager Presents to MRB” 1610 where the fleet operations group manager presents the technical publications change request to the maintenance board. The method continues to decision step “Does Maintenance Review Board Accept Maintenance Program Change?” 1615. If the MRB does not accept the maintenance program change, the MRB's rejection of the change is routed to the appropriate recipients in the aircraft maintenance organization at “Route MRB Rejection of Mx. Program Change” 1620. This results in a “Rejected TCPR” record 1625. If the MRB accepts the maintenance program change at decision 1615, then the maintenance specifications manual is revised to reflect the approved change at “Revise MSM for Mx. Program Change” 1630. The resulting record is a maintenance specifications manual “MSM” 1635 that contains the updated maintenance program. An “Accepted TPCR for Task Card” record 1570 is provided to “Revise Task Cards as Necessary” 1640 which results in the Task Card 1645.

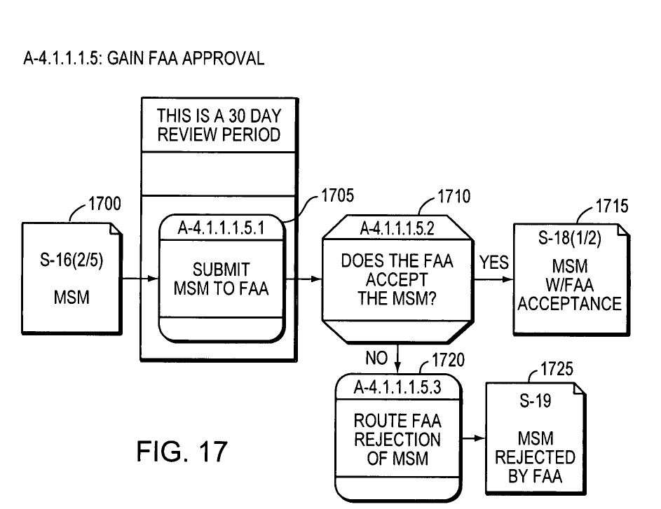

The linked display file shown in FIG. 17 represents a process that can be appear directly below “Gain FAA Approval” 1220 of FIG. 12 in the aircraft maintenance process model hierarchy. A newly revised “MSM” 1700 is provided to “Submit MSM to FAA” step 1705. As is indicated, the FAA review period for such a process change is currently 30 days. The method continues to decision step “Does the FAA Accept the MSM?” 1710. If the FAA does not accept the revised MSM, the FAA's rejection is sent to the appropriate recipients in the aircraft maintenance organization at “Route FAA Rejection of MSM” 1720. The record resulting from step 1720 is the “MSM Rejected by FAA” 1725. If the FAA accepts the MSM, “MSM w/FAA Acceptance” record 1715 results.

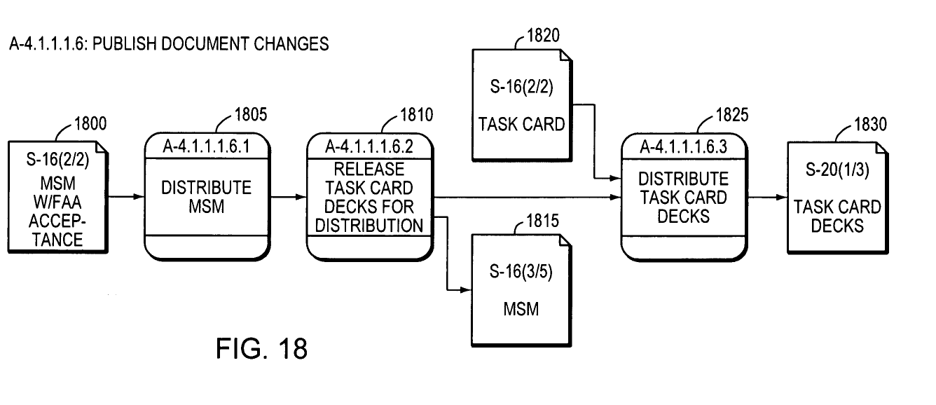

FIG. 18 shows an example of a linked display document that can appear upon selection of “Publish Document Changes” 1225 of FIG. 12. The MSM accepted by the FAA, “MSM w/FAA Acceptance” 1800 is provided to “Distribute MSM” 1805. The process continues to “Release Task Card for Distribution” 1810. The approved “MSM” 1815 record results. From step 1810, the method for publishing document changes continues to “Distribute Task Card Decks” 1825 where “Task Card” record 1820 is used. The output from step 1825 is “Task Card Decks” 1830

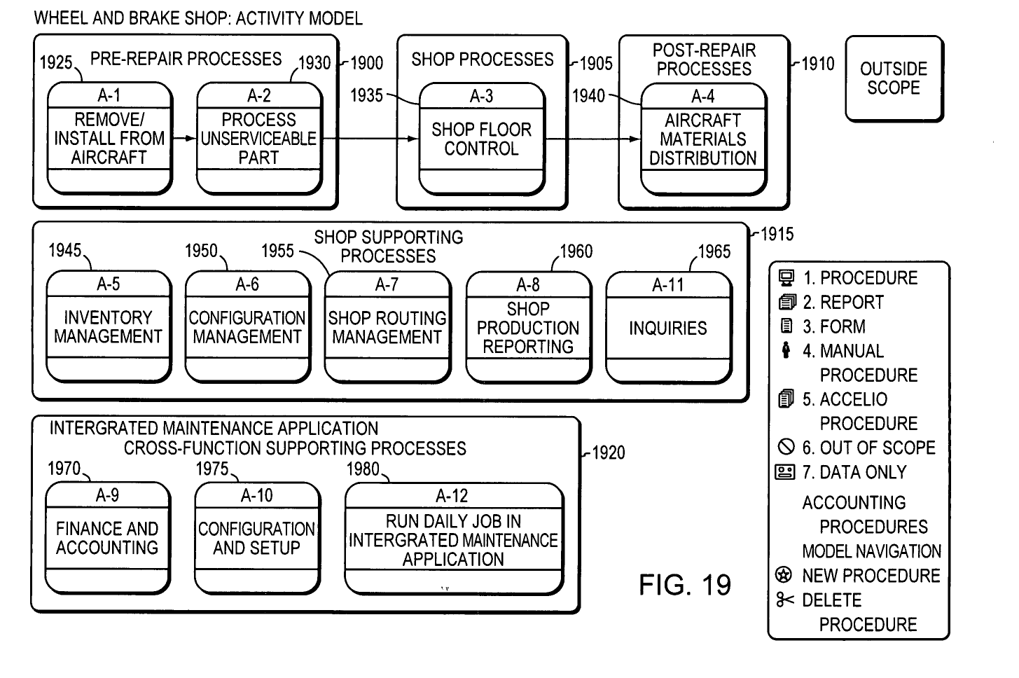

A set of linked display files generated according to the present invention for aircraft wheel and brake maintenance will now be described. FIG. 19 illustrates an example of a display file representing the top level in a hierarchy of linked display files for aircraft maintenance processes within an aircraft fleet wheel and brake shop. The processes within the hierarchy are grouped into five categories: “Pre-Repair Processes” 1900, “Shop Processes” 1905, “Post-Repair Processes” 1910, “Shop Supporting Processes” 1915, and “Integrated Maintenance Application Cross-Function Supporting Processes” 1920. “Pre-Repair Processes” 1900 includes “Remove/Install from Aircraft” 1925, and “Process Unserviceable Part” 1930. “Shop Processes” 1905 includes “Shop Floor Control” 1935. “Post-Repair Processes” 1910 includes “Aircraft Materials Distribution” 1940. “Shop Supporting Processes” 1915 includes “Inventory Management” 1945, “Configuration Management” 1950, “Shop Routing Management” 1955, “Shop Production Reporting” 1960, and “Inquiries” 1965. “Integrated Maintenance Application Cross-Function Supporting Processes” 1920 includes “Finance and Accounting” 1970, “Configuration and Setup” 1975, and “Run Daily Job in Integrated Maintenance Application” 1980.

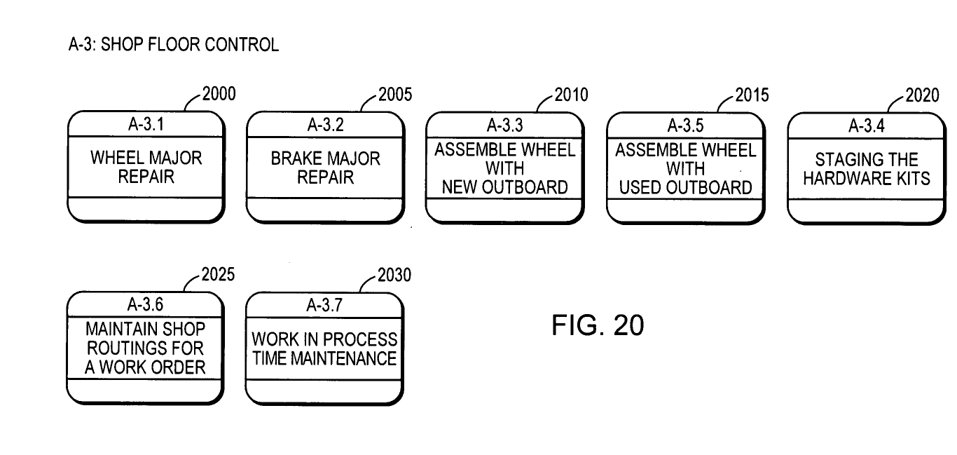

FIG. 20 shows an example of a display file that can be shown upon the selection of “Shop Floor Control” 1935 of FIG. 19. The linked display file of FIG. 20 shows “Wheel Major Repair” 2000, “Brake Major Repair” 2005, “Assemble Wheel with New Outboard” 2010, “Assemble Wheel with Used Outboard” 2015, “Staging the Hardware Kits” 2020, “Maintain Shop Routings for a Work Order” 2025, and “Work in Process Time Maintenance” 2030.

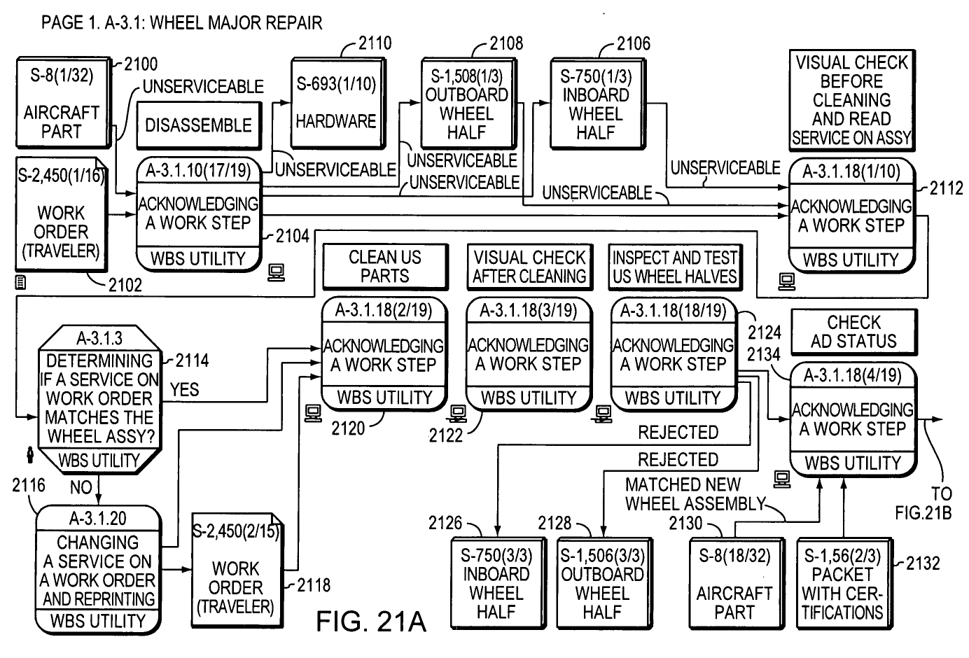

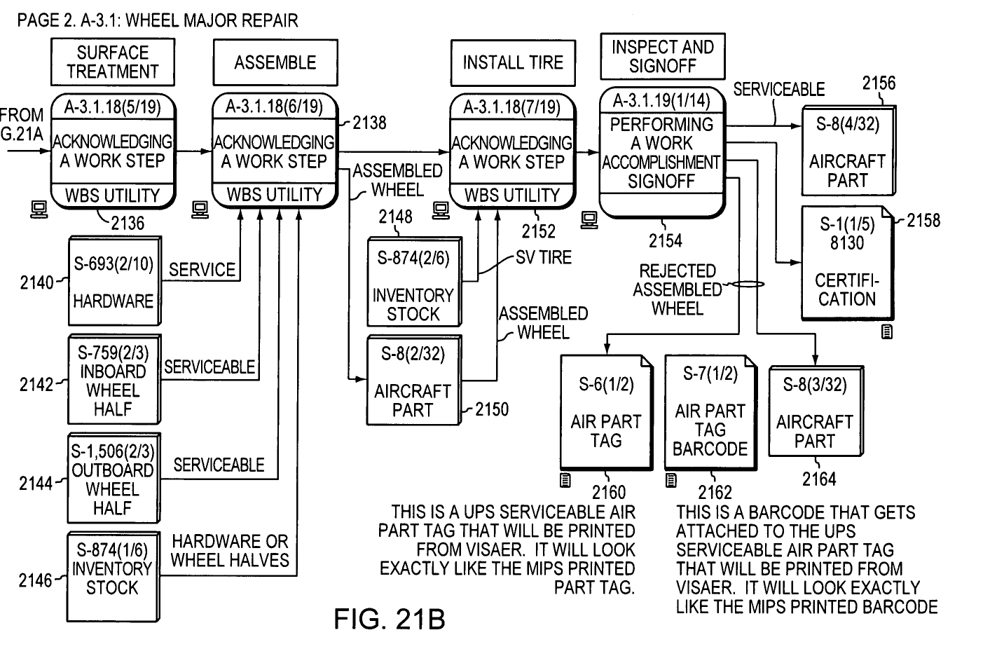

FIGS. 21A and 21B show a display file that can be located in a maintenance process hierarchy below “Wheel Major Repair” 2000 of FIG. 20, and can be displayed upon the selection of “Wheel Major Repair” 2000 of FIG. 20. The box “Aircraft Part” 2100 represents an aircraft wheel assembly that is to be repaired. Paper icon “Work Order (Traveler)” 2102 represents an information “store” that will serve as a record of the work performed by the maintenance shop throughout the process. The term “traveler” is commonly used to refer to a shop document that follows a component throughout its time within the shop. It identifies work scope to be accomplished as well as providing a recording method for work accomplishment. It also serves as the legal teardown report for each repair cycle. In this case the traveler can be an actual document attached to the aircraft parts to identify them as well as an electronic version of the same that is stored in an integrated aircraft maintenance application. Arrows are shown from “Aircraft Part” 2100 and “Work Order (Traveler)” 2102 to “Acknowledging a Work Step” 2104. The arrows indicate that the wheel assembly and the traveler are inputs to step 2104 where the wheel is disassembled and the disassembly is recorded. The disassembly can be recorded in an integrated aircraft maintenance application.

The disassembly step 2104 results in three groups of aircraft parts that comprised the wheel assembly: an “Inboard Wheel Half” 2106, an “Outboard Wheel Half” 2108, and Hardware 2110. The “Inboard Wheel Half” 2106 and “Outboard Wheel Half” 2108 are used as inputs to step 2112 where a visual check of these parts is performed. At step 2114 it is determined whether a service listed on the work order (traveler) matches the work to be performed on the wheel assembly. If the work order does not list the service to be performed, the work order is reprinted at “Changing a Service on a Work Order and Reprinting” 2116. This can be accomplished through the use of an aircraft maintenance application. Changing a service on a work order and reprinting results in “Work Order (Traveler)” 2118 with a service listed that matches the work to be performed. The maintenance process continues to “Acknowledging a Work Step” 2120 where the parts are cleaned and the cleaning step is recorded in the maintenance application. Step 2120 follows step 2114 if the work order lists the service to be performed, and follows step 2116 if the work order needs updating.

After the wheel parts are cleaned, and visual inspection occurs at step 2122. Completion of the visual inspection is recorded in the maintenance application. After the parts have undergone the visual check, a more thorough inspection is performed at step 2124 where the wheel halves are inspected and tested. Completion of the inspection and test is recorded in an aircraft maintenance application. If the inboard or outboard wheel halves fail the inspection and/or test, the parts are rejected. This is depicted in FIG. 21A by boxes 2126 and 2128 showing that the rejected parts are removed from the process. A matched new wheel assembly depicted by box 2130 in the figure replaces these rejected parts. A packet with certifications for the parts accompanies them, which is shown at box 2132 in the figure.

Whether, the original wheel parts pass the inspection and test of step 2124 or those parts are discarded and a new matched wheel assembly is obtained, processing continues to step 2134 where a check is performed to determine the status of any airline directives (AD) that apply to the wheel parts. An AD is an FAA issued directive informing manufacturers of work that needs to be performed on certain aircraft or aircraft parts in order to comply with applicable regulations. The AD status check is recorded in the aircraft maintenance application. Processing continues from this point to FIG. 21B.

Referring now to FIG. 21B, the surfaces of the parts undergo a treatment process at step 2136. This treatment is recorded in an aircraft maintenance application. At step 2138 the parts are assembled. The assembly step can use serviceable hardware or wheel halves such as “Hardware” 2140, “Inboard Wheel Half” 2142, or “Outboard Wheel Half” 2144. If parts are needed from inventory these can be obtained from “Inventory Stock” 2146. The assembled wheel, “Aircraft Part” 2150 is then passed on to step 2152. A serviceable (SV) tire from “Inventory Stock” 2148 is installed on the wheel assembly at step 2152. The installation is recorded in an aircraft maintenance application. At step 2154 the assembled wheel and tire are inspected, and if satisfactory the completion of the service is signed off on and recorded in an aircraft maintenance application. If the wheel and tire assembly are signed off on in step 2154, this step produces an “Aircraft Part” 2156 (the wheel and tire assembly), along with an “8130 Certification” 2158, an “Air Part Tag” 2160, and an “Air Part Tag Barcode” 2162. The 8130 certification is an FAA airworthiness certification indicating that the parts have been serviced according to an FAA approved procedure. The air part tag and its barcode are attached to the aircraft part which can be used to reference and access the records stored in the maintenance application regarding the wheel and tire assembly and the service performed on it. A rejected wheel and tire assembly, “Aircraft Part” 2164, results if the wheel and tire assembly fails the inspection of step 2154.

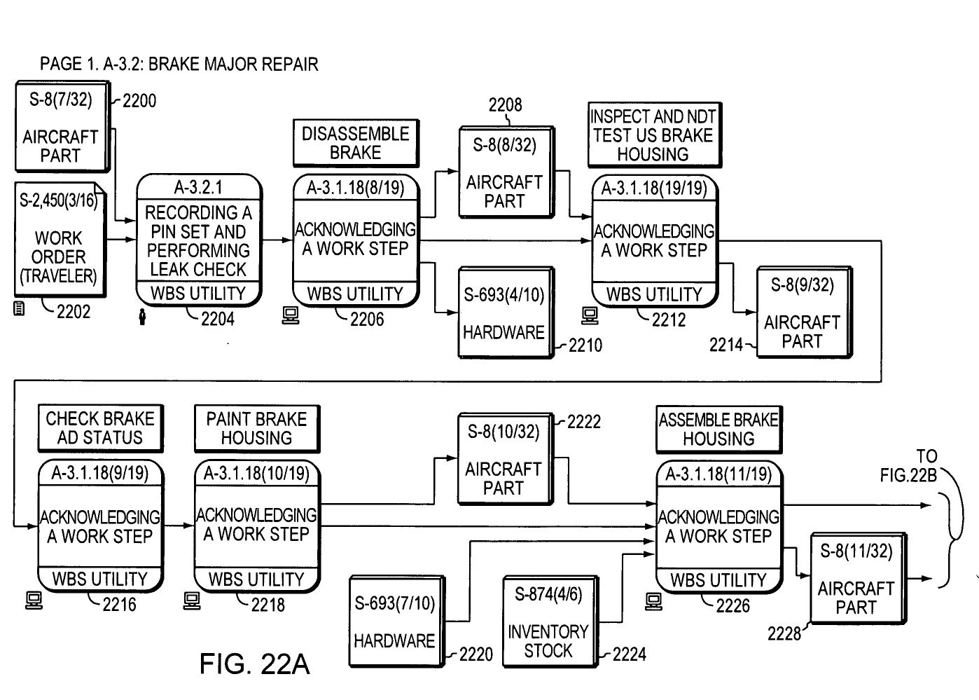

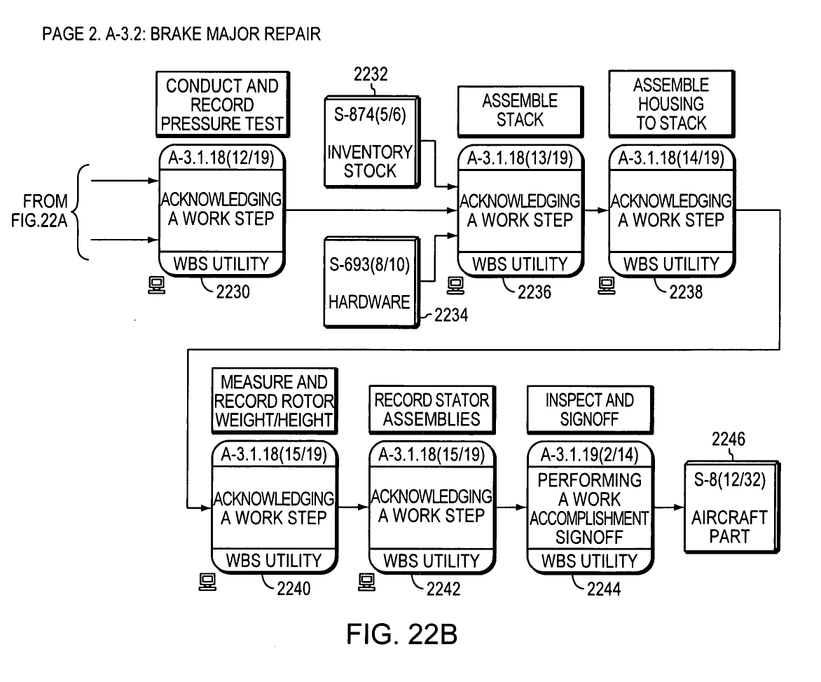

FIG. 22A provides an example of a linked display file that can be displayed upon the selection of “Brake Major Repair” 2005 of FIG. 20. An aircraft brake assembly that has been removed from an aircraft, “Aircraft Part” 2200, along with a “Work Order (Traveler)” 2202 are provided to step 2204, “Recording a Pin Set and Performing Leak Check”. In this step the hydraulics of the brake assembly are checked for leaks and a wear pin indicating remaining brake life is measured. A record of the test is stored in an aircraft maintenance application.

The brake assembly is then disassembled in step 2206 and this action is recorded in the maintenance application. The disassembly results in a brake housing, “Aircraft Part” 2208 and the hardware that was removed from it, “Hardware” 2210. The brake housing is inspected using a nondestructive test (NDT) in step 2212 and the fact that the test has been performed is recorded in the maintenance application. Step 2212 results in a tested brake housing, “Aircraft Part” 2214. Processing continues to step 2216 where a check is performed to determine if there are any applicable airworthiness directives that apply to the brake housing. The performance of the test is recorded in the maintenance application. The brake housing is painted in step 2218, and the completion of the painting step is recorded in an aircraft maintenance application. The painted brake housing, “Aircraft Part” 2222, is then supplied to step 2226 where the aircraft brake is partially reassembled using “Hardware” 2220 and “Inventory Stock” 2224 if required depending on the condition of the existing parts. The assembly step is recorded in an aircraft maintenance application. Continuing to FIG. 22B, the assembly, “Aircraft Part” 2228, is provided to step 2230 where a pressure test is conducted on the assembly and recorded. The performance of the test and the results are recorded in an aircraft maintenance application.

“Inventory Stock” 2232 and “Hardware” 2234 are used in step 2236 to assemble a stack (a layering of brake lining materials) for the aircraft brake. The assembly performed in step 2236 is recorded in an aircraft maintenance application. The assembled stack and the housing are then combined in step 2238. The performance of the assembly step is recorded in an aircraft maintenance application. The rotor weight and height (thickness) of the brake assembly is measured in step 2240 and recorded in an aircraft maintenance application. The stator assemblies of the brake are recorded in an aircraft maintenance application in step 2242. In step 2244 an inspection of the completed brake assembly is performed and if the parts satisfactorily pass the test then the service procedures performed are signed off on. The signoff is recorded in an aircraft maintenance application. The procedure results in a completed and approved brake assembly, “Aircraft Part” 2246.

The foregoing examples represent linked display files of aircraft maintenance processes according to the present invention. The example maintenance processes depicted are presented for purposes of illustration. Depicting different maintenance processes with linked display files is within the scope of the invention. The linked displays of the present invention can comprise web pages linked by hyperlinks, and the display files of the present invention can comprise html files, xml files, other markup language files, or other formats that provide linking capabilities. These display files can be displayed on a computer or other processor based device having a visual display device such as a monitor.

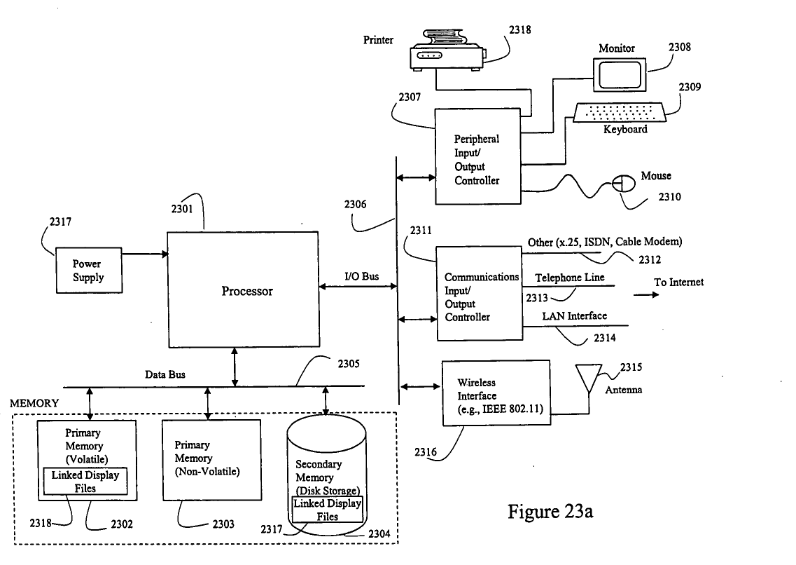

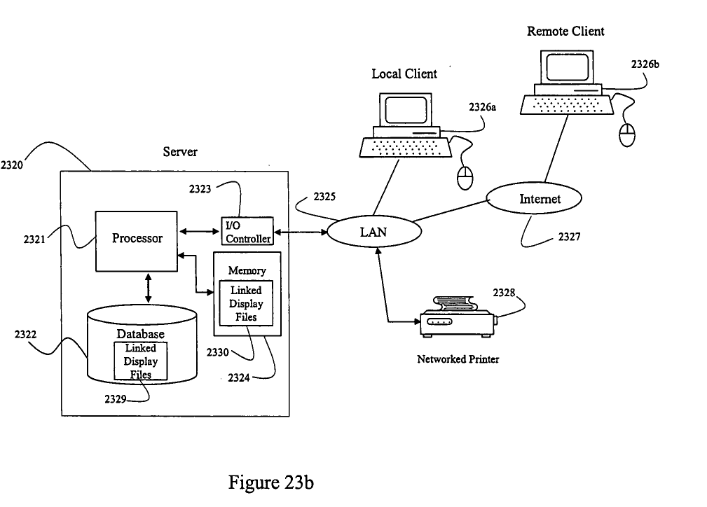

Method steps of the present invention can be completed by updating computer memories or transferring information from one computer memory to another. Examples of computer components that can be used to implement the present invention are described in FIGS. 23a and 23b. Turning to FIG. 23a, one embodiment of a computer is illustrated that can be used to practice aspects of the present invention. The systems and methods of the present invention can be implemented using computer hardware and computer readable memory containing information and instructions to carry out the disclosed method. In FIG. 23a, a processor 2301, such as a microprocessor, is used to execute software instructions for carrying out the defined steps. The processor receives power from a power supply 2317 that also provide power to the other components as necessary. The processor 2301 communicates using a data bus 2305 that is typically 16 or 32 bits wide (e.g., in parallel). The data bus 2305 is used to convey data and program instructions, typically, between the processor and memory. In the present embodiment, memory can be considered primary memory 2302 that is RAM or other forms which retain the contents only during operation, or it may be non-volatile 2303, such as ROM, EPROM, EEPROM, FLASH, or other types of memory that retain the memory contents at all times. The memory could also be secondary memory 2304, such as disk storage, that stores large amount of data. In some embodiments, the disk storage may communicate with the processor using an I/O bus 2306 instead or a dedicated bus (not shown). The secondary memory may be a floppy disk, hard disk, compact disk, DVD, or any other type of mass storage type known to those skilled in the computer arts. One of ordinary skill will recognize that as data is transferred between two or more computing devices (in accordance with the above-described processing steps), the data is read from and written to one or more of these memory areas and the memory area is physically changed as a result of the process.

The processor 2301 also communicates with various peripherals or external devices using an I/O bus 2306. In the present embodiment, a peripheral I/O controller 2307 is used to provide standard interfaces, such as RS-232, RS422, DIN, USB, or other interfaces as appropriate to interface various input/output devices. Typical input/output devices include local printers 2318, a monitor 2308, a keyboard 2309, and a mouse 2310 or other typical pointing devices (e.g., rollerball, trackpad, joystick, etc.).

The processor 2301 typically also communicates using a communications I/O controller 2311 with external communication networks, and may use a variety of interfaces such as data communication oriented protocols 2312 such as X.25, ISDN, DSL, cable modems, etc. The communications controller 2311 may also incorporate a modem (not shown) for interfacing and communicating with a standard telephone line 2313. Finally, the communications I/O controller may incorporate an Ethernet interface 2314 for communicating over a LAN. Any of these interfaces may be used to access the Internet, intranets, LANs, or other data communication facilities.

Finally, the processor 2301 may communicate with a wireless interface 2316 that is operatively connected to an antenna 2315 for communicating wirelessly with another devices, using for example, one of the IEEE 802.11 protocols, 802.15.4 protocol, or a standard 3G wireless telecommunications protocols, such as CDMA2000 1x EV-DO, GPRS, W-CDMA, or other protocol.

Linked display files 2317 and 2318 are shown in the primary and secondary memories 2302 and 2304 of FIG. 23a. The linked display files 2317 can be stored in secondary memory 2304. From the secondary memory 2304 the linked display files can be read by the processor and placed into primary memory 2302. Placing the linked display files in primary memory 2302 increases the speed at which they can be accessed by the processor. The linked display files 2318 can be displayed on the monitor 2308 where they can be navigated by a user through the use of the mouse 2310 and/or the keyboard 2309.

An alternative embodiment of a processing system than may be used is shown in FIG. 23b. In this embodiment, a distributed communication and processing architecture is shown involving a server 2320 communicating with either a local client computer 2326a or a remote client computer 2326b. The server 2320 typically comprises a processor 2321 that communicates with a database 2322, which can be viewed as a form of secondary memory, as well as primary memory 2324. The processor also communicates with external devices using an I/O controller 2323 that typically interfaces with a LAN 2325. The LAN may provide local connectivity to a networked printer 2328 and the local client computer 2326a. These may be located in the same facility as the server, though not necessarily in the same room. Communication with remote devices typically is accomplished by routing data from the LAN 2325 over a communications facility to the Internet 2327. A remote client computer 2326b may execute a web browser, so that the remote client 2326b may interact with the server as required by transmitted data through the Internet 2327, over the LAN 2325, and to the server 2320.

Linked display files 2329 can be stored in the database 2322. The processor 2321 can be configured to transfer the linked display files 2329 from the database 2322 to a remote client 2326b or a local client 2326a. Such a transfer can involve placing linked display files 2330 into memory 2324 for more efficient access.

Those skilled in the art of data networking will realize that many other alternatives and architectures are possible and can be used to practice the principles of the present invention. The embodiments illustrated in FIGS. 23a and 23b can be modified in different ways and be within the scope of the present invention as claimed.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
generating a plurality of linked display files arranged in a hierarchy, one of the linked display files including a general level diagram defining a plurality of divisions of aircraft maintenance processes, and at least one other display file linked to the basic level diagram having basic level diagrams for respective divisions, the basic level diagrams defining respective tasks required to perform respective aircraft maintenance processes.

2. A method as claimed in claim 1 wherein the display files are linked so that a user can navigate with a computer from the display file for the general level diagram to the display file for at least one basic level diagram for an aircraft maintenance process selected by the user with the computer.

3. A method as claimed in claim 1 wherein the general level diagram displays aircraft maintenance processes for supply chain management, engineer to order, configuration management, operations, finance and accounting (F&A), planning systems (MRP), customer relationship management (CRM), and business to employee.

4. A method as claimed in claim 1 wherein at least one task defined in the basic level diagrams includes replacing an aircraft part.

5. A method as claimed in claim 1 wherein at least one task defined in the basic level diagram includes inspecting an aircraft part.

6. A method as claimed in claim 1 wherein at least one task defined in the basic level diagram includes servicing an aircraft part.

7. A method as claimed in claim 1 wherein at least one task defined in the base level diagrams requires at least one input element to perform the task.

8. A method as claimed in claim 7 wherein the input element comprises a tool.

9. A method as claimed in claim 7 wherein the input element comprises a worker with a certain skill.

10. A method as claimed in claim 7 wherein the input element comprises a part.

11. A method as claimed in claim 7 wherein the input element comprises a record.

12. A method as claimed in claim 7 wherein the input element comprises data.

13. A method as claimed in claim 1 wherein at least one task defined in the base level diagram requires at least one output element.

14. A method as claimed in claim 13 wherein the output element comprises a report.

15. A computer-readable medium storing a plurality of linked display files arranged in a hierarchy, one of the linked display files including a general level diagram defining a plurality of divisions of aircraft maintenance processes, and other display files linked to the display file for the general level diagram having basic level diagrams for respective divisions, the basic level diagrams defining respective tasks required to perform respective aircraft maintenance processes.

16. The computer-readable medium of claim 15 wherein the display files are linked so that a user can navigate with a computer from the display file for the general level diagram to the display file for at least one basic level diagram for an aircraft maintenance process selected by the user with the computer.

17. The computer-readable medium of claim 15 wherein the general level diagram displays aircraft maintenance processes for supply chain management, engineer to order, configuration management, operations, finance and accounting (F&A), planning systems (MRP), customer relationship management (CRM), and business to employee.

18. The computer-readable medium of claim 15 wherein at least one task defined in the basic level diagrams includes replacing an aircraft part.

19. The computer-readable medium of claim 15 wherein at least one task defined in the basic level diagram includes inspecting an aircraft part.

20. The computer-readable medium of claim 15 wherein at least one task defined in the basic level diagram includes servicing an aircraft part.

21. The computer-readable medium of claim 15 wherein at least one task defined in the basic level diagram requires at least one input element to perform the task.

22. The computer-readable medium of claim 21 wherein the input element comprises a tool.

23. The computer-readable medium of claim 21 wherein the input element comprises a worker with a certain skill.

24. The computer-readable medium of claim 21 wherein the input element comprises a part.

25. The computer-readable medium of claim 21 wherein the input element comprises a record.

26. The computer-readable medium of claim 21 wherein the input element comprises data.

27. The computer-readable medium of claim 15 wherein at least one task defined in the base level diagram requires at least one output element.

28. The computer-readable medium of claim 27 wherein the output element comprises a report.

29. A method comprising:
generating a hierarchy of displays of aircraft maintenance processes with a succession of levels from a general level comprising at least one maintenance process, to a basic level defining at least one task to perform the process.

30. A method comprising:
analyzing tasks performed by a plurality different business units to generate a single cross-business-unit thread for a specific aircraft maintenance process; and
generating an aircraft process diagram modeling the aircraft maintenance process having a plurality of tasks performed by different business units.

31. A method comprising:
identifying tasks performed by at least one business unit of an aircraft maintenance organization;
grouping the tasks into at least one aircraft maintenance process of interdependent tasks;
identifying input and output elements for the grouped tasks; and
generating an aircraft maintenance process diagram based on the grouped tasks and associated input and output elements.

32. A method as claimed in claim 31 further comprising:
displaying the aircraft maintenance process diagram with a computer.
